(19) United States
(12) Patent Application Publication
(10) Pub. No.: US 2007/0071987 A1
(43) Pub. Date: Mar. 29, 2007

(54) Base-inhibited oxidative polymerization of thiophenes and anilines with iron (III) salts

(75) Inventor: Bjorn Winther-Jensen, East Hawthorn (AU)

Correspondence Address: BUCHANAN, INGERSOLL & ROONEY PC, POST OFFICE BOX 1404, ALEXANDRIA, VA, 22313-1404, US

(73) Assignee: NANON A/S, Brondby (DK)

(21) Appl. No.: 11/582,381

(22) Filed: Oct. 18, 2006

Related U.S. Application Data
(63) Continuation-in-part of application No. PCT/DK05/00257, filed on Apr. 14, 2005.

(30) Foreign Application Priority Data
Apr. 20, 2004 (DK) PA 2004 00620

(51) Int. Cl. C08G 75/00; B32B 27/34; B05D 3/02

(52) U.S. Cl. 428/474.4; 528/373; 427/384

(57) ABSTRACT

The present invention relates to improved methods for the preparation of electrically conducting polymer layers, and to polymer layers showing unprecedented electrical conductivity. In one embodiment, a layer of a polymer of a monomer selected from thiophenes and anilines is prepared by applying a solution comprising the monomer, an Fe(III) salt, an amine/amide having a pKa value of at least 1.0 selected from tertiary amines, tertiary amides and aromatic amines, and a solvent, wherein the molar ratio of the amine/amide to the Fe(III) salt is in the range of 0.35-1.25 to the surface of a substrate, and allowing the monomer to polymerize.

### CROSS-REFERENCE TO RELATED APPLICATIONS

The present application is a continuation in part of PCT/DK2005/000257, filed on Apr. 14, 2005, and which claims the priority of PA 2004 00620, filed in Denmark on Apr. 20, 2004. The entire contents of PCT/DK2005/000257 and PA 2004 00620 are incorporated herein by reference.

### FIELD OF THE INVENTION

The present invention relates to improved methods for the preparation of electrically conducting polymer layers, and to polymer layers showing unprecedented electrical conductivity.

### BACKGROUND OF THE INVENTION

Among the different conducting polymers used in practical applications, poly(3,4-ethylenedioxythiophene) (PEDT) is known as a particularly robust and well conducting system [1]. PEDT is available from Bayer AG as an aqueous suspension (Baytron P) that can be conveniently coated onto a number of different surfaces by printing or spinning techniques. The resulting bluish, transparent polymer layer can obtain conductivities in the range from 0.1 up to 10 S/cm [1], which is more than sufficient for applications as antistatic coatings for which it was originally developed. PEDT is by itself insoluble, but the use of a water soluble polyelectrolyte, poly(styrene sulfonic acid) (PSS), as the charge balancing counter ion, has made it possible for Bayer AG to formulate Baytron P as a stable PEDT/PSS suspension that at the same time shows excellent film forming properties. Although the conductivity of the resulting films can be increased in a number of ways, e.g., by changing the solvent [2], Baytron P does not express the full possibilities of PEDT in terms of conductivity. This is not surprising as the requirements for high conductivity (first of all long, unperturbed polymer chains) may be difficult to combine with solution processing.

PEDT can be produced by direct chemical oxidation of the monomer. This is mostly used for the production of bulk polymers, but de Leeuw [3] has developed a direct oxidative polymerization method suitable for formation of surface films. By an adaptation of this method conductivities up to 550 S/cm have been reported for PEDT [4]. It is, however, not trivial to obtain reproducible, homogeneous films using this method.

Bayer AG ships both the 3,4-ethylenedioxythiophene (EDT) monomer (Baytron M) and an oxidative solution of ferric para-toluene sulfonate (Fe(III) tosylate) in butanol (Baytron C). Spinning a mixture of these two ingredients onto a surface enables one to obtain PEDT films. But to get a homogeneous film requires great skill, and the pot-life of the polymerization mixture is only 10-20 minutes before PEDT forms insoluble flocculates in the solution. This makes practical use difficult and made us look for alternative routes to highly conducting PEDT surface films.

Previously we have shown that the EDT monomer can participate in an acidity driven polymerization, whereby a partially conjugated polymer is formed [5]. The aim for the present work was to find synthesis routes where the acidity can be controlled both before the reaction is desirable (longer pot-life, no crystal formation in the solution) as well as during the reaction (preventing unwanted acidic side reactions). The work can be seen as a further development of de Leeuw's method [3].

Vapor phase polymerization (VPP) has been used for making conducting polymers. The method was originally described by Mohammadi et al [10] as a CVD process using FeCl₃ or H₂O₂ as oxidizing agents for polymerization of polypyrrole films. It was later adapted for the formation of well-defined surface patterns of polypyrrole using patterned copper converted to CuCl₂ as the oxidation agent [11]. VPP has also been used for in situ polymerization of polypyrrole inside a number of different non-conducting polymers and rubbers. This was first reported by Ueno et al [12], who made a conducting composite by exposing PVC blended with FeCl₃ to pyrrole vapors. In 1998 Fu et al. [13] showed promising results using Fe(III) tosylate as oxidizing agent for VPP of pyrrole in a polyurethane foam, but no further results was reported. Recently the first use of VPP to produce PEDT has been reported [7]. Films with conductivities around 70 S/cm was obtained using FeCl₃ as oxidizing agent.

Recently, we have found a group of very well suited basic inhibitors among the tertiary amines, tertiary amide and aromatic amines, especially aromatic amines such as pyridine.

### BRIEF DESCRIPTION OF THE DRAWINGS

FIG. 1 shows a schematic drawing of the vapour phase polymerisation chamber.

FIG. 2 shows the Cyclic Voltammograms (CV) of PEDT's (on Pt-PET) polymerised with pyridene as basic inhibitor (scan rate 100 mV/s, electrolyte 0.1 M TBAP).

FIG. 3 shows the conductivity as function of temperature for PEDT and PEDT/Loctite3311 in an Arrhenius plot.

FIG. 4 shows the response of quartz crystal microbalance during vapour phase polymerisation of EDT on Fe(III) tosylate in air. EDT temperature: 30° C., airflow rate: 260 ml/min. The frequency change is transformed into mass change by the Sauerbrey equation.

FIG. 5 shows the response of quartz crystal microbalance during vapour phase polymerisation in nitrogen of EDT on a crystal coated with para-toluene sulfonic acid. EDT temperature: 30° C., flow rate: 260 ml/min.

FIG. 6 shows the surface resistance of a BI VPP PEDT-film on glass measured at different currents. The thickness of this sample is 250 nm and the bulk conductivity calculated from the surface resistivity at 1 mA is 1025 S/cm.

FIG. 7 shows SEM micrographs of BI VPP PEDT before and after ethanol rinse.

FIG. 8 shows UV-VIS spectra of BI VPP PEDT (thick full line) deposited onto a PET foil compared to VPP PEDT deposited on a PET foil with Fe(III) tosylate, washed in ethanol (broken line) and post-Ox VPP PEDT (thin full line).

FIG. 9 shows FTIR spectra of the EDT monomer (thick full line) on a PE membrane compared to VPP PEDT deposited on a aluminium foil (all polymerised using Fe(III) tosylate) washed in ethanol (broken line) and post-Ox VPP PEDT (thin full line). The insert is a comparison of BI VPP PEDT (thick full line) with post-Ox VPP PEDT in the frequency interval 1800 to 800 cm⁻¹.

FIG. 10 shows Raman spectra of BI VPP PEDT (thick solid line) compared with VPP PEDT deposited on a PET foil with Fe(III) tosylate, washed in ethanol (broken line) and post-Ox VPP PEDT (thin full line).

FIG. 11 shows Cyclic Voltammograms (CV) of Pt coated PET foils with BI VPP PEDT (thick solid line) compared to post-Ox VPP PEDT (thin line). Electrolyte: 0.1 M tetrabuthylammonium hexafluorophosphate in acetonitrile, scan rate: 100 mV/s.

### DESCRIPTION OF THE INVENTION

The present inventors have identified novel and useful methods for the preparation of layers of a polymer of selected thiophenes and anilines. Such layers show high electrical conductivity.

Films Cast from a Solution

Thus, one aspect of the present invention relates to a method for the preparation of a layer of a polymer comprising a monomer selected from the group consisting of thiophenes of the formula I and anilines of the formula II 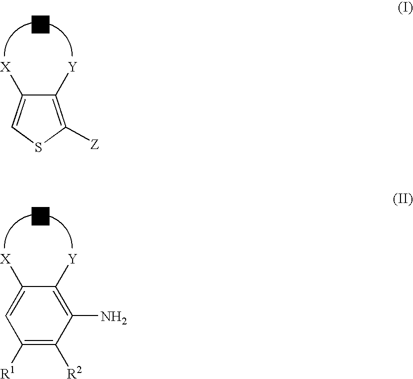
wherein X and Y independently are selected from the group consisting of —CH₂— and —O—, with the proviso that at least one of X and Y is —O—; R is optionally substituted C₁₋₄-alkylene; Z is selected from hydrogen and amino; and R¹ and R² independently are selected from the group consisting of hydrogen, hydroxy, C₁₋₆-alkyl, C₁₋₆-alkoxy, C₁₋₆-alkoxycarbonyl, C₁₋₆-alkoxycarbonyl, formyl, aryl, amino, mono- and di(C₁₋₆-alkyl)amino, carbamoyl, mono- and di(C₁₋₆-alkyl)amino-carbonyl, amino-C₁₋₆-alkyl-aminocarbonyl, mono- and di(C₁₋₆-alkyl)amino-C₁₋₆-alkyl-aminocarbonyl, C₁₋₆-alkylcarbonylamino, cyano, carbamido, C₁₋₆-alkanoyl-oxy, sulphono (—SO₃H), C₁₋₆-alkylsulphonyloxy, nitro, sulphanyl, dihalogen-C₁₋₄-alkyl, trihalogen-C₁₋₄-alkyl, and halogens; on a predetermined part of the surface of a substrate, said method comprising the steps of:

(a) providing a solution comprising the monomer, an Fe(III) salt, an amine/amide having a pKa value of at least 1.0 selected from tertiary amines, tertiary amides and aromatic amines, and a solvent, wherein the molar ratio of the amine/amide to the Fe(III) salt is in the range of 0.35-1.25;

(b) applying the solution to the predetermined part of the surface of the substrate; and

(c) allowing the monomer to polymerize.

In one embodiment the layer of a polymer may comprise two or more of the thiophene and aniline monomers as defined herein.

Monomers

The monomers, i.e. the thiophenes and anilines, are as defined hereinabove.

X and Y are independently selected from the group consisting of —CH₂— and —O—, with the proviso that at least one of X and Y is —O—; X and Y are preferably both —O—.

The biradical R is optionally substituted C₁₋₄-alkylene. If substituted, the biradical R typically carries 1-3, such as 1-2, substituents. Illustrative examples of substituents which may be present are hydroxy, C₁₋₆-alkyl, C₁₋₆-alkoxy, C₁₋₆-alkoxycarbonyl, C₁₋₆-alkylcarbonyl, formyl, aryl, amino, mono- and di(C₁₋₆-alkyl)amino, carbamoyl, mono- and di(C₁₋₆-alkyl)aminocarbonyl, amino-C₁₋₆-alkyl-aminocarbonyl, mono- and di(C₁₋₆-alkyl)amino-C₁₋₆-alkyl-aminocarbonyl, C₁₋₆-alkylcarbonylamino, cyano, carbamido, C₁₋₆-alkanoyloxy, sulphono (—SO₃H), C₁₋₆-alkylsulphonyloxy, nitro, sulphanyl, dihalogen-C₁₋₄-alkyl, trihalogen-C₁₋₄-alkyl, and halogens. Preferred examples are hydroxy, C₁₋₆-alkyl, C₁₋₆-alkoxy, C₁₋₆-alkoxycarbonyl, C₁₋₆-alkylcarbonyl, amino, mono- and di(C₁₋₆-alkyl)amino, and halogen.

The biradical R is preferably unsubstituted ethylene, i.e. the group X-R-Y forms an ethylenedioxy group.

Z is selected from hydrogen and amino. Preferably, Z is hydrogen. R¹ and R² independently are selected from the group consisting of hydrogen, hydroxy, C₁₋₆-alkyl, C₁₋₆-alkoxy, C₁₋₆-alkoxycarbonyl, C₁₋₆-alkylcarbonyl, formyl, aryl, amino, mono- and di(C₁₋₆-alkyl)amino, carbamoyl, mono- and di(C₁₋₆-alkyl)amino-carbonyl, amino-C₁₋₆-alkyl-aminocarbonyl, mono- and di(C₁₋₆-alkyl)amino-C₁₋₆-alkyl-aminocarbonyl, C₁₋₆-alkylcarbonylamino, cyano, carbamido, C₁₋₆-alkanoyl-oxy, sulphono (—SO₃H), C₁₋₆-alkylsulphonyloxy, nitro, sulphanyl, dihalogen-C₁₋₄-alkyl, trihalogen-C₁₋₄-alkyl, and halogens. Preferably R¹ and R² are both hydrogen.

In view of the details given above, the monomer is preferably selected from the group consisting of 3,4-ethylenedioxythiophene (EDT), 2-amino-3,4-ethylenedioxythiophene, and 2,3-ethylenedioxyaniline, in particular the monomer is 3,4-ethylenedioxythiophene. The invention is illustrated in the Examples section with reference to 3,4-ethylenedioxythiophene although other monomers are also believed to be useful.

Amines/Amides

In the present description and claims, the terms “amines/amides” and “amine/amide” are intended to mean “amines and/or amides” and “amine and/or amide”, respectively.

In a particularly interesting embodiment, the term should have the meaning “amine”, thus referring to tertiary amines and aromatic amines (see below).

The amine to be used in the stabilized solution and methods of the invention should in one embodiment be an amine and/or an amide (i.e. amine/amide) having a pKa value of at least 1.0 selected from tertiary amines, tertiary amide and aromatic amines. Thus in one embodiment, the amine/amide (here amine) is selected from tertiary amines, in particular selected from the group consisting of cyclic tertiary amines (such as 4-methylmorpholine, 1-methylpiperidine, 1-methylpyrrolidine); in another embodiment, the amine/amide (here amide) is selected from tertiary amide, in particular cyclic tertiary amides (such as N-methyl-pyrrolidone, N-vinyl-pyrrolidone and 3-methyl-2-oxozolidinone); and in still another embodiment, the amine/amide (here amine) is selected from aromatic amines, in particular selected from the group consisting of pyridine, N-methyl-imidazole, quinoline and isoquinoline. In a particularly interesting embodiment, the amine is selected from the group consisting of pyridine and derivatives of pyridine. A mixture of amines and/or amides may of course be used.

It is believed to be advantageous to select the aromatic amines among those that do not contain an N—H group, e.g. aromatic amines should in one embodiment either contain an —N═ group or an —NR— group.

A general requirement to the amine/amide is its pKa value which must be at least 1.0, in particular the amine/amide has a pKa value of at least 2.0, such as in the range of 2.0-10.0, such as in the range of 3.5-7.0.

It is furthermore preferred, with regard to the ability of the amine/amide to evaporate after application of the solution to the predetermined part of the surface of the substrate, that the amine has a boiling point at 101.3 kPa of in the range of 50-210° C., such as in the range of 100-190° C.

Fe(III) salt

The Fe(III) salt is typically one where the corresponding acid of the salt has a pKa value below 2.0. Illustrative examples of suitable Fe(III) salts are those selected from Fe(III) sulfonates and Fe(III) phosphates, in particular the Fe(III) tosylate salt. A mixture of Fe(III) salts may of course also be used.

The term Fe(III) salt should be interpreted to included the salt as such as well as the salt in dissolved condition when the salt is in the presence of a solvent.

A further important feature of the invention is that the molar ratio of the amine/amide to the Fe(III) salt is in the range of 0.35-1.25, in particular in the range of 0.4-1.0.

Although less critical, it is also preferred that the molar ratio between the monomer and the Fe(III) salt is in the range of 1:1.5 to 1:3.0, such as in the range of 1:2.0 to 1:2.5.

Solvent

The solvent is added in order to obtain a suitable viscosity of the solution. Illustrative examples of suitable solvents are those selected from alcohols, water, ethers, acetates, glycols, glycerol and carboxylic acids, in particular the alcohols such as ethanol. A mixture of solvents may of course also be used.

Substrate

A wide range of substrates are suitable in the methods of the invention, thus typically the solid substrate essentially consists of a material selected from polymers, e.g. polyolefins such as polyethylene (PE) and polypropylene (PP), and polystyrene (PS), and other thermoplastics such as fluoro-polymers (e.g. polytetrafluoroethylene (PTFE), tetrafluoroethylene-hexafluoropropylen copolymers (FEP), and

polyvinyl-difluoride (PVDF)), polyamides (e.g. nylon 6 and nylon-11), polyvinylchloride (PVC), and rubbers; organosiloxane-based materials (e.g. silicone rubbers); glasses; silicon; paper; carbon fibres; ceramics; metals; etc.

It is often advantageous to prepare a predetermined pattern of the polymer layer, thus, the solution is preferably only applied to this predetermined part of the surface of the substrate. The pattern can be obtained by masking, by ink-jet printing, by imprint, by offset printing or by silk screen printing.

The substrate may be part of an object, or the substrate as such may constitute an object. Examples of very interesting objects for which the present invention is particularly applicable are micro-flow systems, “Lab on a chip”, flat screens, solar cells, membranes, fabrics, clothes, and woven and non-woven fiber materials.

Step (a)

The first step (a) of the method is to provide a solution comprising the monomer, an Fe(III) salt, an amine/amide having a pKa value of at least 1.0 selected from tertiary amines, tertiary amides and aromatic amines (in particular tertiary amines and aromatic amines), and a solvent, wherein the molar ratio of the amine/amide to the Fe(III) salt is in the range of 0.35-1.25. Care should be taken in this preparation step, because the Fe(III) salt and the amine/amide have to be mixed in the solvent before the monomer is added, and the temperature should preferably be kept at 25° C. or lower.

Step (b)

In a subsequent step (b), the solution is applied to the predetermined part of the surface of the substrate. The solution is typically applied by spraying, dipping, printing or spin coating.

Step (c)

In a final step (c), the monomer is allowed to polymerize. The polymerization process can be promoted by elevating the temperature to 40-150° C., such as 40-90° C., and/or by applying reduced pressure in order to remove the solvent and the amine/amide.

Step (d)

The method may comprise the additional step (d) of washing the polymer film so as to remove the Fe(II)/Fe(III) salt and any remaining amine/amide. The reduced Fe(II) salt and excess of amine/amide and Fe(III) salt has no positive effect on the conducting polymer and is therefore unwanted in the conductive layer. These unwanted products are easily removed by washing the conducting polymer once or twice with water or ethanol.

Addition of a Polymer or Polymer Precursor

In one embodiment, the solution in step (a) further comprises a polymer or a polymer precursor which provides advantages with respect to activation energy (see the Experimentals section). Examples of such polymer precursors are curable glues, such as heat or UV-curable glues.

Vapor Phase Polymerization of Films

Another aspect of the invention relates to a method for the preparation of a layer of a polymer of a monomer selected from the group consisting of thiophenes of the formula I and anilines of the formula II 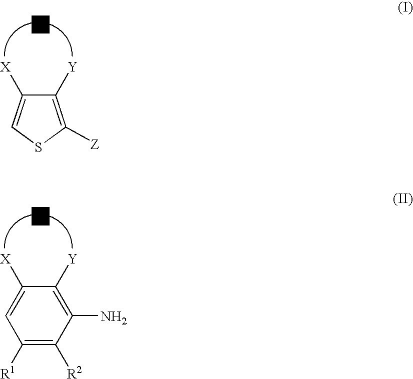
wherein X and Y independently are selected from the group consisting of —CH₂— and —O—, with the proviso that at least one of X and Y is —O—; R is optionally substituted C₁₋₄-alkylene; Z is selected from hydrogen and amino; and R¹ and R² independently are selected from the group consisting of hydrogen, hydroxy, C₁₋₆-alkyl, C₁₋₆-alkoxy, C₁₋₆-alkoxycarbonyl, C₁₋₆-alkylcarbonyl, formyl, aryl, amino, mono- and di(C₁₋₆-alkyl)amino, carbamoyl, mono- and di(C₁₋₆-alkyl)amino-carbonyl, amino-C₁₋₆-alkyl-aminocarbonyl, mono- and di(C₁₋₆-alkyl)amino-C₁₋₆-alkyl-aminocarbonyl, C₁₋₆-alkylcarbonylamino, cyano, carbamido, C₁₋₆-alkanoyl-oxy, sulphono (-SO₃H), C₁₋₆-alkylsulphonyloxy, nitro, sulphanyl, dihalogen-C₁₋₄-alkyl, trihalogen-C₁₋₄-alkyl, and halogens;

on a predetermined part of the surface of a substrate, said method comprising the steps of:

(a) providing a solution comprising an Fe(III) salt, an amine/amide having a pKa value of at least 1.0 selected from tertiary amines, tertiary amines and aromatic amines, and a solvent, wherein the molar ratio of the amine/amide to the Fe(III) salt is in the range of 0.35-1.25;

(b) applying the solution to the predetermined-part of the surface of the substrate so as to form a film on said predetermined part of the surface of the substrate;

(c) exposing said film to a vapor comprising the monomer, and allowing said monomer to polymerize.

As it will be realized, the specifications and preferences with respect to the monomer(s), the amine(s)/amide(s), the Fe(III) salt, the solvent and the substrate is as described above for “Films cast from a solution”. Furthermore, the method may—as above—comprise the additional step (d) of washing the polymer film so as to remove the Fe(II)/Fe(III) salt and any remaining amine.

Step (a)

The first step (a) of the method is to provide a solution comprising an Fe(III) salt, an amine/amide having a pKa value of at least 1.0 selected from tertiary amines, tertiary amides and aromatic amines, and a solvent, wherein the molar ratio of the amine/amide to the Fe(III) salt is in the range of 0.35-1.25. This is typically done by simple mixing of the constituents. It should be noted that the solution does typically not include a monomer, although a minor amount of monomer may be present, if desirable.

Step (b)

In a subsequent step (b), the solution is applied to the predetermined part of the surface of the substrate so as to form a film on said predetermined part of the surface of the substrate. The solution is typically applied by spraying, dipping, printing or spin coating. During and after the drying of the Fe(III) salt/(amine/amide) mixture it is advantageous to raise the temperature to 40-70° C. This helps to avoid formation of large crystals in the film.

Step (c)

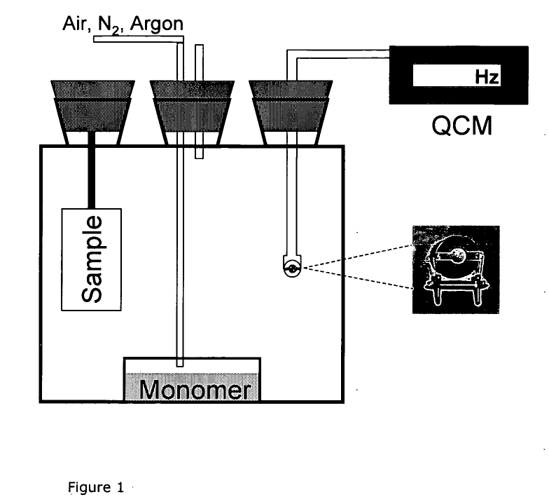

In a final step (c), the film is exposed to a vapor comprising the monomer, and the monomer is allowed to polymerize. During the polymerization, which may last for more than one hour, it is advantageous to raise the temperature in the polymerization chamber (FIG. 1) to 40-1.50° C., such as 40-90° C. or 40-80° C. and float the chamber with a selected gas. This facilitates evaporation of the amine/amide and speeds up the polymerization.

Step (d)

The method may comprise the additional step (d) of washing the polymer film so as to remove the Fe(II)/Fe(III) salt and any remaining amine/amide. The reduced Fe(II) salt and excess of amine/amide and Fe(III) salt has not positive effect on the conducting polymer and is therefore unwanted in the final product. These unwanted products are easily removed by washing the conducting polymer once or twice with water or ethanol.

Addition of a Polymer or Polymer Precursor

In one embodiment, the solution in step (a) further comprises a polymer or a polymer precursor. Examples of such polymer precursors are curable glues, such as heat or UV-curable glues. This embodiment appears to be particularly relevant for this aspect of the invention.

Further Aspects of the Invention

In view of the first of the above-mentioned aspects, it has also been found that the stabilized solution prepared in step (a) constitutes a particularly interesting aspect of the invention.

Thus, the invention also provides a stabilized solution of a polymerizable solution comprising a monomer selected from thiophenes of the formula I and anilines of the formula II and an Fe(III) salt in a solvent, said solution further comprising an amine/amide having a pKa value of at least 1.0 selected from tertiary amines, tertiary amides and aromatic amines, wherein the molar ratio of the amine/amide to the Fe(III) salt is in the range of 0.35-1.25.

It has also proven possible to obtain substrates with a layer of an electrically conducting polymer layer with an unprecedented conductivity.

Thus, the present invention also provides a substrate comprising a layer of poly(3,4-ethylenedioxythiophene) on at least a part of the surface thereof, said layer having a conductivity of at least 700 S/cm. The layer is preferably prepared according to one of the methods defined herein.

Preferred Embodiment

In a currently most preferred embodiment of the aspects of the invention, the monomer is 3,4-ethylenedioxythiophene (EDT), the Fe(III) salt is Fe(III) tosylate, and the amine/amide is pyridine.

### EXPERIMENTAL SECTION AND DISCUSSION

### Example 1

PEDT coatings were formed on PET foils or glass slides using the two methods outlined below:

PEDT Film Cast from a Solution

For this method Fe(III) tosylate was used as oxidizing agent and pyridine as acidity-regulator during the polymerization of PEDT.

2.25 mol of Fe(III) tosylate and 1.1 mol pyridine were used per mole EDT monomer: 6.5 mL 40% Fe(III) tosylate in butanol (“Baytron C” from Bayer AG) was first mixed with 0.15 mL pyridine and 6.5 mL butanol (the extra butanol was added to achieve a more suitable viscosity and thereby the desired thickness of the final PEDT film), then 0.22 mL of EDT was added under stirring.

This mixture had a pH of around 2.5 (as measured directly with a pH probe).

The mixture was coated on the surfaces by a hand coater (R.K. Print Coat Instruments Ltd.). After the solvent had evaporated, and no liquid was visible, the sample was placed on a hot-plate at 50° C. This step prevented formation of Fe(III) tosylate crystals (i.e. gave smooth and coherent films) and speeded up the evaporation of pyridine and thereby the polymerization of EDT. After one hour at 50° C., the sample was cooled for 5 min and then washed twice in ethanol in order to remove Fe(III) tosylate and remaining pyridine.

Alternatively, the solution was spin-coated on glass-slides (1450 rpm, 90 s) followed by polymerization at room temperature over the next two hours. The samples were finally washed twice in ethanol in order to remove Fe(III) tosylate and remaining pyridine.

Vapor Phase Polymerization (VPP) of PEDT Films

For this method the oxidation agent, Fe(III) tosylate (40% in butanol), was mixed with pyridine in the molar ratio of 2:1. Additional solvent could be added to control the film-formation when the mixture was distributed on the substrates.

When almost dry, the samples were placed on a hot-plate at 50° C. This prevented formation of Fe(III) tosylate crystals (i.e. gave smooth and coherent films). After ˜1 min at the hot-plate, the dry films were moved directly to a glass polymerization chamber (FIG. 1) with EDT vapor at 50° C. The chamber was flushed with N₂ (50 mL/min). The pyridine slowly evaporated and the polymerization of EDT started.

After 1 hour, the samples were removed from the polymerization chamber and again placed on the hot-plate at 50° C. After 1 hour, the samples were washed twice in ethanol and dried in air in order to remove Fe(III) tosylate and remaining pyridine.

In an additional experiment, a UV- and heat-curable glue (Loctite 3311) was added to the Fe(III) tosylate/pyridine mixture (⅙ volume of the 40% solution). After coated on glass, the glue was cured before the VPP by heating for 1½ min at 100° C., and then the samples were transferred to the VPP chamber.

### Example 2

Preparation of PEDT Film using N-methylpyrrolidinone as Basic Inhibitor

In this example Fe(III) tosylate was used as oxidizing agent and N-methylpyrrolidinone as acidity-regulator during the polymerization of PEDT.

2.25 mol of Fe(III) tosylate and 1.2 mol pyridine were used per mole EDT monomer: 6.5 mL 40% Fe(III)tosylate in ethanol was first mixed with 0.19 mL N-methylpyrrolidinone, then 0.22 mL of EDT was added under stirring.

The mixture was spin-coated on glass slides and PET-foils (2000 rpm, 60 s). During the spin-coating the solvent had evaporated and the polymerization was carried out in an oven at 60° C. for 20 minutes. The samples were washed twice in 0.05 molar para-toluene-sulfonic acid in order to remove Fe(III) tosylate and remaining N-methylpyrrolidinone and finally dried at 60° C. for 60 minutes.

The thickness of the resulting blue PEDT film was measured to 200 nm and the resistance was 68 ohm/sqr giving a conductivity of 735 S/cm.

After storing the mixture 48 hours at room temperature an identical polymerization experiment was preformed. This time the conductivity of the final PEDT film was only 420 S/cm.

Discussion

de Leeuw successfully used imidazole [3] to control the speed of polymerization of EDT with Fe(III) tosylate. Imidazole acted as a base decreasing the activity of Fe(III). In fact de Leeuw showed that the polymerization of coatings containing EDT, Fe(III) tosylate and imidazole did not start before the imidazole was removed by heating to 105° C.

Imidazole, however, has some drawbacks as inhibitor in the EDT/Fe(III) tosylate system: A) Imidazole—as most other N—H containing chemicals—binds as ligands to Fe(III) leading to formation of crystals in the solution, which among other problems causes uneven films. B) Imidazole has to be removed by heating before the polymerization starts. Often it is desirable to use lower temperature (because of substrate etc.) or even room temperature. We know that the acid initiated polymerization of EDT is not taking place in poly(acrylic acid) with a pKa value around 2.2 [5], so we looked for basic compounds with pKa higher than this—but with lower melting/boiling point than imidazole and without N—H groups.

Pyridine, pyrazine and quinoline where tried. None of these compounds formed crystals with Fe(III) in the solution.

Pyrazine (pKa 0.37, melting point 55° C., boiling point 115° C.) is not a strong enough base to seriously decrease the activity of Fe(III)—no real inhibition was observed.

Quinoline (pKₐ4.85, boiling point 230° C.) worked fine as inhibitor in the solution, although it took some time or heat to remove the quinoline from the films because of the low vapour pressure of quinoline. During this process some EDT monomer (boiling point 190° C.) also evaporated and was thereby lost. But nice conducting blue films were actually obtained by this method.

Pyridine turned out to have the best combination of properties as inhibitor for this system (pKₐ5.14, boiling point 115° C.). The pot-life was extended to 3 days at room temperature (20% Fe(III) tosylate in butanol, 0.5 mole pyridine per mole Fe(III)) and 7 days at 4° C.—using closed and dark containers.

Good film-forming properties were achieved by spin coating or casting. To make thicker films, heating to 50° C. was necessary to avoid crystal formation during drying, presumably due to formation of hydrates by uptake of moisture from the air.

After washing with ethanol the conductivity was measured in a range of currents applied and routinely conductivities around 1000 S/cm was obtained. This result is quite surprising because it has earlier been reported [6], that the use of pyridine as inhibitor for EDT polymerization with Fe(III) tosylate was resulting in poor polymerization and not leading to conducting films.

The pure PEDT/tosylate films obtained from vapor phase polymerization had conductivity levels in the same range as the films cast from solution.

Also analysis using UV-VIS, FTIR and Raman spectroscopy showed no difference depending on the polymerization procedure—and was also in agreement with the literature.

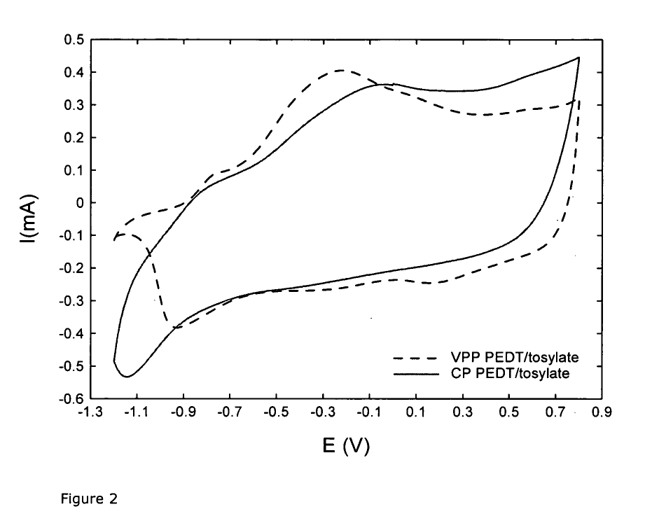

By using cyclic voltametry (CV) differences however showed up (FIG. 2). It seems that the films obtained by vapour phase polymerisation are reacting faster to changes in the voltage than the films cast from solution. This may be because the VPP is leading to films with less defects and higher mobility due to the longer polymerisation time. In this regard, the VPP films are similar to films polymerized electrochemically.

The VPP route is opening new possibilities for patterning, because the mixture of oxidant and basic inhibitor can be patterned before the VPP e.g. by ink-jet printing. This requires that the oxidant and inhibitor does not form crystals before or under the VPP, which may lead to uneven films. For this reason FeCl₃ is not a good candidate for making micro patterned PEDT by use of VPP [7].

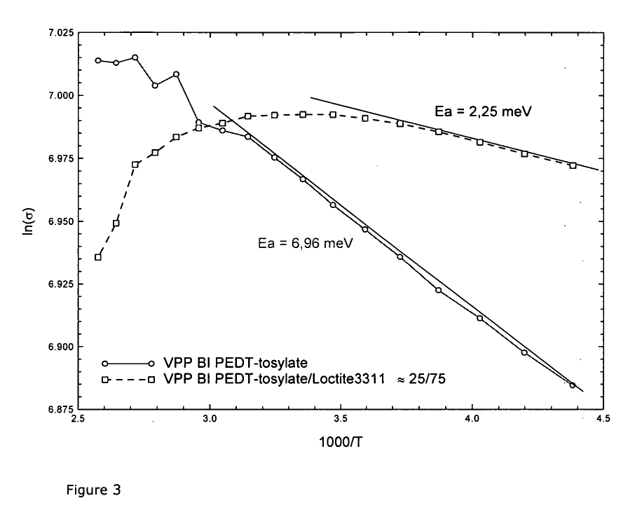

The films obtained from VPP on a mixture of Loctite 3311, Fe(III) tolylate and pyridine (25% PEDT, 75% Loctite 3311, total thickness 260 nm) showed some very surprising properties. First, the conductivity of the film increased during the first 3 days after the polymerisation and the post VPP treatment (baking for ½ h at 60° C., washing twice in 0.2 M H₂SO₄ (50% H₂O, 50% ethanol) and finally baking for 1 h at 60° C.). Based on the total film thickness, the increase was from 750 to 870 S/cm. If the conductivity is calculated using the actual PEDT content in the film (260 nm/4=65 nm) the conductivity is 870*4=3480 S/cm. Secondly, the conductivity as function of temperature was measured and compared to pure VPP PEDT in an Arrhenius plot (FIG. 3). The shape of the two curves was different. Pure VPP PEDT shoved classic semiconductor behaviour with continuous increasing conductivity with increasing temperature. The PEDT mixed with Loctite 3311 showed a curve with a maximum around room temperature and a decrease in conductivity at higher temperatures (“metallic behaviour”).

The activation energy Eₐ was calculated at lower temperatures for both films from
σ=σₛ* exp(−Eₐ/kT)

The activation energy, Eₐ, turns out to be more than 3 times lower for PEDT mixed with Loctite than for pure PEDT (2.25 meV vs 6.96 meV). This correlates well with the high conductivity (calculated on basis of the PEDT content) seen for PEDT mixed with Loctite 3311.

This surprising effect could not be explained from a change in the structure of the conducting polymer when the PEDT/tosylate is forming an interface with the Loctite 3311 glue. X-ray scattering showed no difference between PEDT/tosylate and PEDT/tosylate/Loctite3311 samples.

Conclusions

Pyridine was found to be an ideal inhibitor to control the polymerisation process of EDT. It can be applied both to the conventional polymerisation from a solution and to vapour phase polymerisation. A number of other possible inhibitors can be imagined—the general requirement is that they must have a pKₐ of at least 1.0, such as at least.2.0, and preferably a boiling point in the range of 50-210° C. and should not contain N—H groups.

A difference between PEDT films cast from solution and films obtained by VPP was observed in the CV's of these films. VPP PEDT shows the faster response and is in this sense similar to PEDT formed by electrochemical polymerisation.

The formation of PEDT with high conductivity by VPP opens a route whereby micro-patterning can be made only by patterning the oxidant/ inhibitor mixture.

This may be a substantial advantage in combination with the employment of ink-jet and other industrial printing technologies. Keeping oxidant and monomer separate until after the patterning step avoids the problems with limited pot-life and clogging of nozzles etc.

Mixtures of VPP PEDT with non-conducting glue gave conducting films with very low activation energy. The reason for this phenomenon has yet to be investigated in details.

### Example 3

The EDT monomer (Baytron M) and Fe(III) tosylate (40% solution in butanol, Baytron C) was received from Bayer AG. Para-toluene sulfonic acid (PTSa) and pyridine was obtained from Aldrich. All chemicals where used as received.

Vapor phase polymerization was carried out in a simple single-chamber set-up as shown on FIG. 1. The chamber was typically flushed with air, nitrogen or argon during the polymerisation, and a heater provided the possibility to raise the temperature of the monomer reservoir (to 30-50° C.) in order to speed up the process. The samples to be covered with PEDT were initially coated with the oxidant, e.g. a butanol or ethanol solution of Fe(III) tosylate. After drying at 60° C. in air, the samples were transferred to the polymerization chamber.

The polymerization chamber was equipped with a quartz crystal microbalance (QCM) that was used to monitor the progress of the polymerization process. It was based on a 10 MHz crystal (from ICM, Oklahoma City) that could be coated with the same oxidant as the substrates prior to exposure to EDT vapor. Weight changes in the surface film on the crystal could then be detected as changes in the resonant frequency of the crystal. An oscillator (Lever Oscillator, ICM) connected to a frequency counter (FLUKE PM6680B) excited the crystal, and the change in frequency was followed by logging the analog output from the frequency counter. The lever oscillator also output a signal that allowed the estimation of the damping of the oscillation due to non-rigid deposits.

The polymer coatings on the substrates were characterized by UV-VIS spectroscopy (Shimadzu UV1700), FTIR (Perkin Elmer, Spectrum One with an STI “Thunderdome” ATR system) and Raman spectroscopy (Lab Raman Infinity Spectrometer with a confocal microscope. Spectra obtained with an excitation wavelength of 676 nm). Some coatings were further characterized by cyclic voltammetry (CV) in a standard three-electrode cell using an Autolab potentiostat. The conductivity of the samples was measured using a four-point probe from Jandel Engineering Ltd connected to a Keithly 2400 source meter. The probe is equipped with four spring loaded tungsten carbide needles spaced 1 mm apart. During a measurement sequence the current through the sample is changed from a low level where the potential drop over the sample is in the μV range to the current level where the potential is well above 10 mV. To eliminate errors from thermo voltages and voltmeter offsets two current pulses of opposite signs are used for each measurement point. Both high and low currents may lead to relatively large measurement errors, and the surface resistivity is extracted from an intermediate current range where the resistivity is independent on the applied current. The bulk resistivity of the films is calculated from the surface resistivity using the film thickness measured by a DekTak profilometer.

Direct Polymerization of EDT on Fe(III) tosylate and PTSa

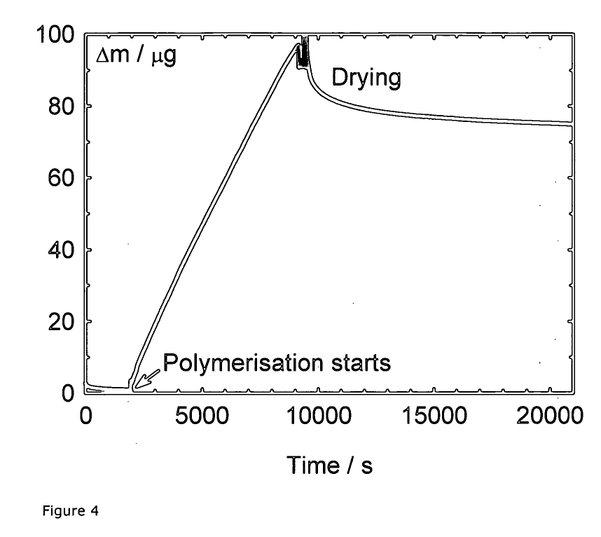

Initially direct oxidation using the commercially available Baytron C solution of Fe(III) tosylate in butanol was tried because this oxidant is known to produce highly conducting PEDT¹. Exposing Fe(III) tosylate to EDT vapor could be expected to give PEDT according to the equation: 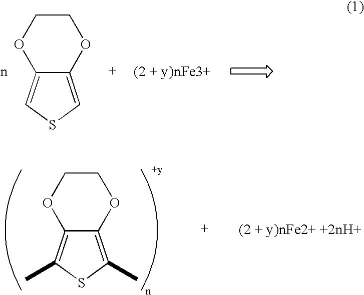
Assuming that the over-oxidation, y, is 0.25 [14] one would then expect to gain≈63 g PEDT per mol Fe(III) tosylate. The results from the QCM measurements, however, gave a very different result as illustrated on FIG. 4. In this experiment 22.1 nmol Fe(III) tosylate was initially coated onto the quartz crystal, and the expected mass gain from polymerization is 1.4 μg. At time 2000s the quartz crystal with Fe(III) tosylate is transferred to the polymerization chamber and the mass on the crystal starts to increase. At time 9100 s the QCM stops oscillating due to a combination of high mass loading and a high damping from a viscous (non-rigid) deposit. The QCM is subsequently taken out of the polymerization chamber and placed in a drying chamber flushed with air (260 ml/min) where non-reacted EDT is allowed to evaporate. Soon after the QCM starts oscillating again, and after 20000 s the total mass increase is 71 μg. This is 50 times more than expected from reaction (1), indicating that the polymerization is not only caused by oxidation by Fe(III) tosylate. The experiment was repeated in both nitrogen and argon atmosphere with similar results, ruling out the possibility that oxygen is driving the polymerization reaction. The brownish coatings obtained from direct vapor phase polymerization of EDT on Fe(III) tosylate turned green after Fe(III) and Fe(II) tosylate was removed by washing in ethanol. The resistivity of the deposits was very high (>1 GΩ/sq), indicating that the product was not PEDT. In an attempt to make NMR analysis on the VPP films dissolution was attempted with different solvents (chloroform, methanol, ethanol, acetone, water and acetic acid), but without success. This supports the notion that the films are indeed polymeric.

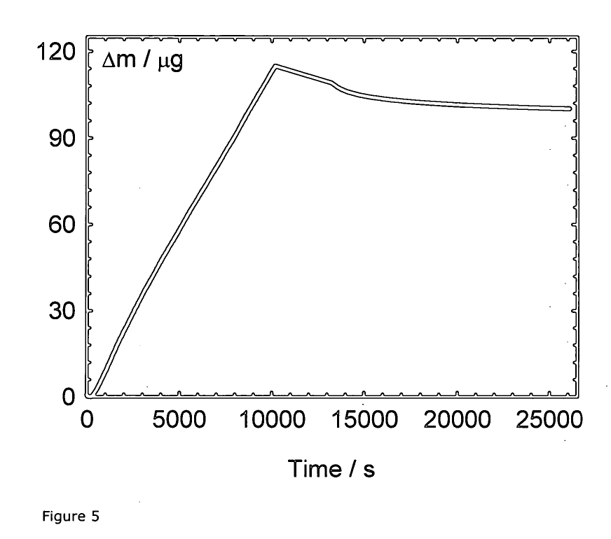

As the polymerization process is not driven by oxidation by Fe(III) or oxygen, the high acidity of Fe(III) tosylate might be the critical factor. To test this hypothesis, a quartz crystal coated with 3470 ng (18.9 nmol) of para-toluerne sulfonic acid (PTSa) was placed in the vapor phase polymerization chamber; the QCM curve is shown on FIG. 5. Again the polymerization continues until the QCM crystal is removed from the polymerization chamber at time 10000 s. After drying, the gain in mass is 96.8 μg—or 36 mol of EDT polymerized per mol PTSa employed. When PTSa is exchanged with poly(acrylic acid) no film is formed. This indicates that a strong acid is needed to drive this kind of polymerization.

Base Inhibited VPP of EDT

The results above show for this embodiment that acid initiated polymerization of EDT requires a pH lower than what can be provided by poly(acrylic acid). On the other hand, a low pH is essential for the use of Fe(III) tosylate, which is preferred to other oxidation agents such as ammonium peroxydisulfate because of its good film forming properties. The question is whether there is a pH range where reaction (1) is preferred over the acid initiated polymerization?

Using an alkaline inhibitor the pH of the Fe(III) tosylate solution in butanol can be raised, which at the same time decreases the redox activity of Fe(III)⁵. By choosing a liquid base with a relatively high vapor pressure, the pH at the substrate will slowly decrease until the polymerization according to reaction (1) starts. If the sample is then removed before the acid initiated polymerization takes over, a conducting PEDT film should be formed.

Pyridine was chosen as the basic inhibitor, and the pH of the Fe(III) tosylate solution was raised (to 2.5 measured by a pH probe, but the low water content of the solution makes the absolute value uncertain) by adding half a mole of pyridine per mole of Fe(III) tosylate. Samples where prepared using poly(ethylene terephthalate) (PET) foils and platinum-coated PET foils as substrates. The Fe(III) tosylate/pyridine solution was applied to the substrates and dried in air at room temperature until the solvent, butanol, had evaporated. The samples were then further dried for three minutes in an oven at 75° C. before it was exposed to EDT vapor in the vapor polymerization chamber (EDT liquid temperature: 50° C.; N₂ flow rate: 50 ml/min). After 1 hour the samples were removed from the chamber. After another 30 min in air the samples where washed twice in ethanol for 10 min (hereafter referred to as “BI VPP PEDT”).

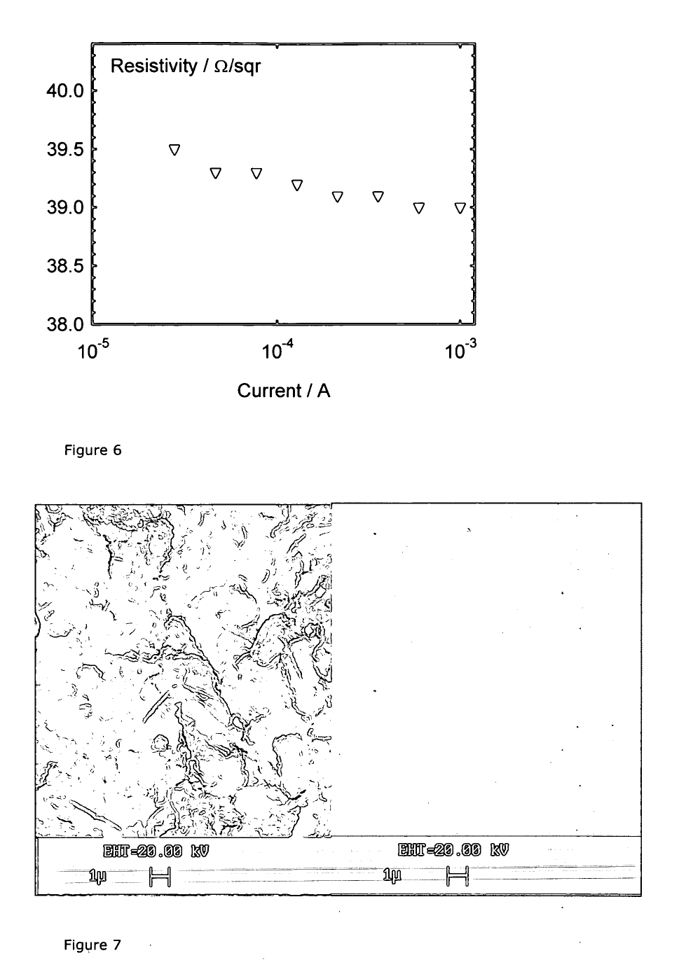

Using this method light blue films were obtained with conductivities that routinely exceeded 1000 S/cm, see FIG. 6. The films are very smooth and without characteristic substructures after a rinse in ethanol to remove the Fe(II) tosylate content, but as seen from the SEM pictures in FIG. 7 the pristine films are quite rough. QCM measurements performed under these synthesis conditions showed only rather small weight changes because the growth of the polymer is counteracted by pyridine evaporation. The total weight change after the crystal is rinsed in ethanol is consistent with reaction (1).

Mechanism of Acid Initiated Polymerization

Acid initiated polymerization of thiophene-derivates has been reported for polymerization of benzo[c]thiophene (isothianaphthene) [15]. The proposed polymerization leads to a non-conjugated polymer, witch can be oxidized in a second step, e.g. by sulfuryl chloride (SO₂Cl₂) [16]:

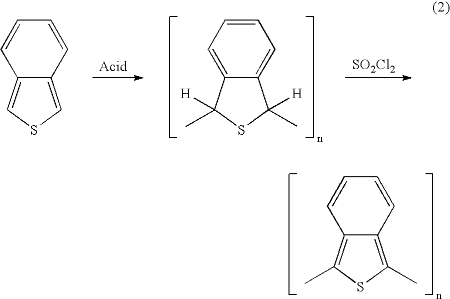

A similar reaction scheme might be possible for PEDT. In that case the intermediate polymer and the oxidation step should have the structure:

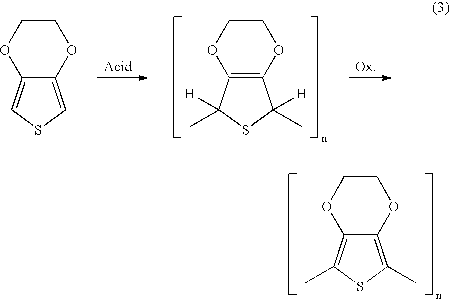

To explore whether this reaction is actually taking place, films obtained from direct vapor polymerization on Fe(III) tosylate and PTSa was subsequently oxidized in an Fe(III) tosylate solution in ethanol (pH regulated to 1.5 with pyridine). After oxidation the films were washed twice in ethanol for 10 min.

This treatment causes the films to change color from green to bluish black, and the films became slightly conducting (1-5 MΩ/sqr), although not in the same range as the films obtained from base inhibited vapor polymerization. Films made by this method are in the following dubbed “post-Ox VPP”.

These results called for further investigations of polymerized EDT films obtained by the different routes. New thicker samples for further analysis where made on PET and platinum coated PET. These samples were exposed in the vapor polymerization chamber (EDT temperature 50° C., N₂ flow 50 ml/min) for two hours, dried for 30 min and subsequently washed twice in ethanol.

UV-VIS

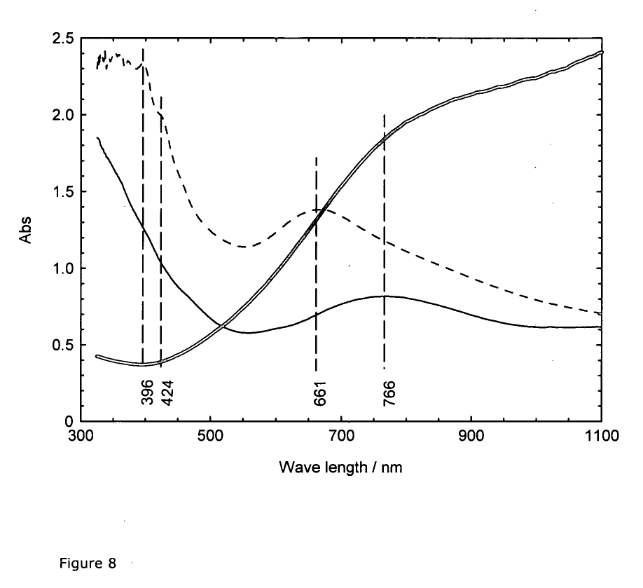

FIG. 8 shows the UV-VIS spectra of VPP films of EDT polymerized on Fe(III) tosylate, post oxidized VPP of EDT on Fe(III) tosylate and BI VPP PEDT. The spectrum of BI VPP PEDT fits well with the spectrum reported for electrochemically oxidized PEDT at potentials around 1000 mV [17]. The spectrum of the post-Ox VPP film, that according to reaction (3) also should be oxidized PEDT, has a minor absorption peak at 766 nm and an increasing absorption in the lower UV range, but no significant similarity to spectra reported for oxidized PEDT.

The VPP P-EDT films on Fe(III) tosylate and PTSa (not shown) have similar characteristics, although the ratio between the peeks are different. The VPP P-EDT films are clearly different from the BI VPP PEDT showing significant absorbance in the 325 to 450 nm range, around 661 nm and—as post-ox VPP P-EDT—very low absorbance over 700 nm. The lack of absorbance above 700 nm shows that the density of the polaronic states, that in oxidized PEDT gives rise to a broad absorption above 600-700 nm, is low which corresponds with the fact that the two VPP PEDT films are poor conductors. Reduced PEDT has an absorption peak at around 600 nm corresponding to excitation of electrons across the band gap of the delocalized, semi conducting states. Neither VPP P-EDT nor post-ox VPP P-EDT shows appreciable absorbance in this region.

FTIR

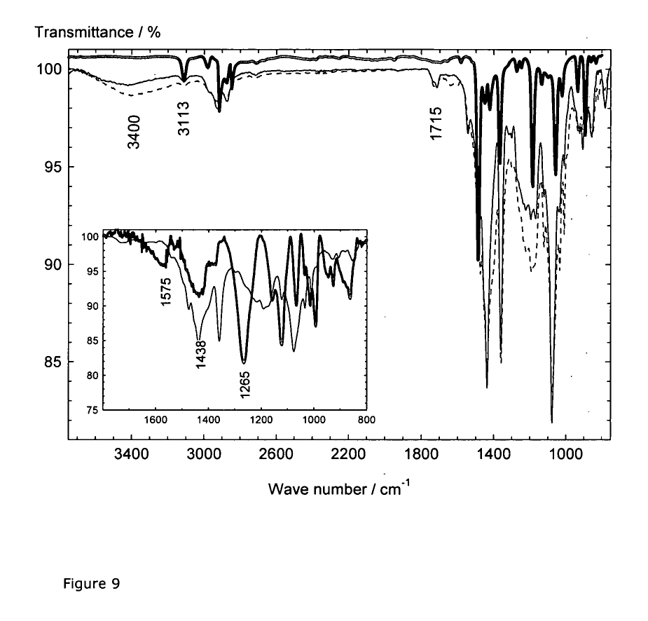

The FTIR spectra of VPP PEDT on PTSa and post-ox VPP PEDT show only minor differences, and are compared to the spectra of the EDT monomer on FIG. 9. The peak at 3116 cm⁻¹ is due to the 2,5-hydrogen atoms on the thiophene ring and is seen both in the EDT monomer and VPP PEDT and (to some extent) in the post-ox VPP PEDT. The peak at 1715 cm⁻¹ is due to a carbonyl group (C═O), and the broad peak around 3400 cm⁻¹ is due to —OH groups—neither of these are found in the EDT monomer. Reaction (3) does not account for the appearance of these peeks in VPP PEDT and post-Ox VPP PEDT. This indicates that (3) is not the only reaction in play. The carbonyl- and the hydroxy-groups can only originate from the oxygen in the monomer's dioxane ring. This shows that part of the monomers has undergone a reaction in the dioxane ring, presumably starting with an ether cleavage during the polymerization reaction.

The FTIR spectra in the interval from 800 to 1700 cm⁻¹ of post-ox VPP PEDT show some similarity to both BI VPP PEDT and what is described for PEDT in the literature [18]. But especially the peaks at 1542 and 1438 cm⁻¹ (C═C region) are different from what was earlier reported.

If the acid initiated polymerization follows reaction (3), the spectra of post-ox VPP PEDT and BI VPP PEDT should be identical—which they apparently are not. The peek at 1575 cm⁻¹ is due the conjugated C═C system, and is seen clearly in BI VPP PEDT but not in post-ox VPP P-EDT. Again this is consistent with the poor conductivity of post-ox VPP PEDT.

Raman Spectroscopy

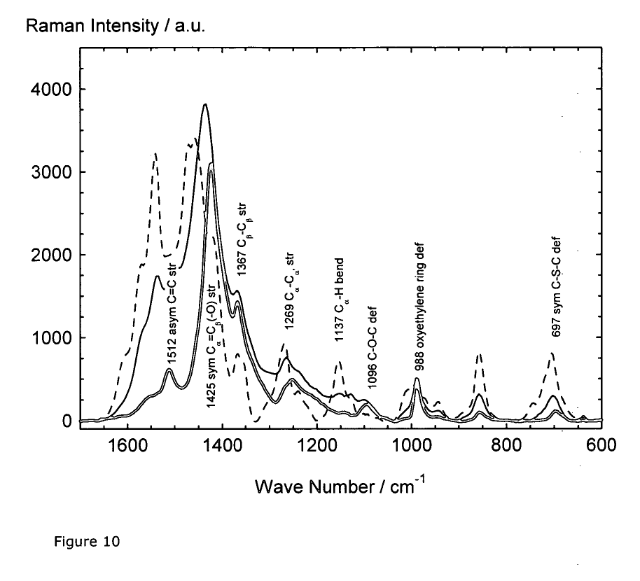

Data from Raman spectroscopy (excitation wavelength 676 nm) are shown in FIG. 10. The spectra of BI VPP PEDT correspond very well with what is reported in the literature [17] for electrochemically oxidized PEDT at positive potentials in the 300-500 mV range. Peaks from pyridine are not seen. Raman spectra of VPP PEDT on Fe(III) tosylate and VPP PEDT on PTSa (not shown) are nearly identical.

At 1137 cm⁻¹ the band from Cₐ-H bend found in the EDT monomer is also present in VPP PEDT. Another peak in the C—H region at 1155 cm⁻¹ (neither present in the EDT monomer nor in PEDT) appears. These two peaks are also found in the post-ox VPP PEDT but with lower intensity. The hydrogen (Cₐ-H) on the thiophene-ring is not (totally) removed, which shows that vapor phase polymerization followed by chemical oxidation does not lead to the formation of a highly conjugated system.

In the C═C stretching region the peaks in post-Ox VPP P-EDT are quite similar to BI VPP PEDT—just shifted to higher wave-numbers. In this part of the spectra post-ox VPP PEDT shows all the bands one would expect from a conjugated polymer, which indicates that at least some parts of the polymer is formed according to reaction (3).

Cyclic Voltammetry

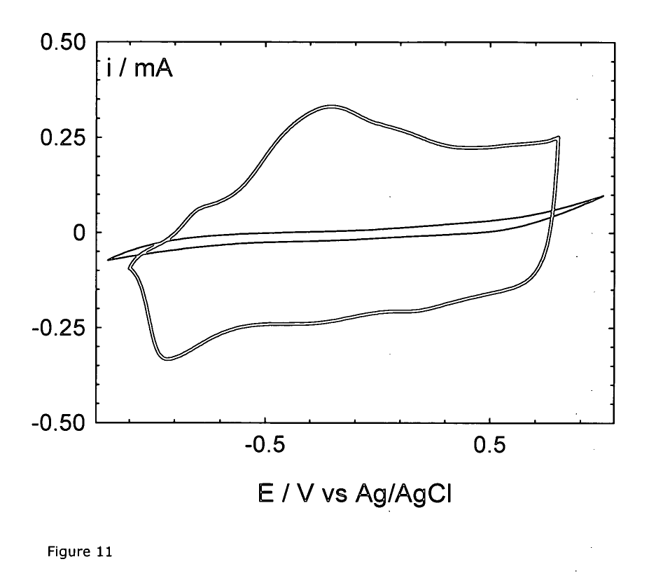

Cyclic voltammetry (CV) is a sensitive method to characterize the redox states and thereby the electronic properties of conjugated polymers. The voltammetry current is proportional to the number of sites that can be reduced or oxidized at a given potential, and this quantity is dependent not only on the chemical composition of the polymer, but also on structural factors such as conjugation length and local order. CV's can thus be used as a kind of fingerprint to identify a given polymer type. On FIG. 11 cyclic voltammograms of BI VPP PEDT and post-Ox VPP PEDT on pTSa are compared. The CV's are recorded at sweep rate 100 mV/s with the polymers deposited on Pt coated PET immersed in a non-aqueous electrolyte (0.1 M tetrabuthylammonium hexafluorophosphate in acetonitrile). It is seen that the electrochemical response of the two polymers are vastly different. BI VPP PEDT shows the larger response, with a shape that is identical to what has previously been reported for electro-polymerized PEDT [17]. The post-Ox VPP PEDT electrode on the other hand shows a much smaller, non-specific response indicating that this material has very few conjugated double bonds that can be oxidized or reduced in this potential interval. This is not a kinetic effect as the same difference is also seen at much lower sweep rates and is consistent with the low conductivity of this polymer compared to BI VPP PEDT.

Alternative to chemical oxidation by Fe(III) VPP PEDT on pTSa can also be oxidized electrochemically under CV conditions. In the first cycles an irreversible oxidation bends the curve upwards at potentials higher than 0.2 V, but after a few cycles, the curve becomes identical to the curve for post-Ox VPP PEDT on FIG. 11. The electrode changes color from green to black during the oxidation process.

In summary, the different analyses of the product of acid initiated polymerization of EDT give contradicting results. It is likely that reaction (3) describes the main reaction route, but it is not the only reaction involved. The conjugation is broken by thiophene rings with saturated bonds, and the dioxyethylene ring undergo occasionally a cleaving reaction. As a result, this reaction does not lead to PEDT in the wanted highly conjugated form-essential for obtaining a good conductivity.

Conclusion

The following conclusion seeks to at least in part explain the function of the invention for at least some of the embodiments thereof. This conclusion should not be used to limit the scope of the invention.

A side-reaction for the polymerization of EDT under acidic condition has been identified. A possible reaction scheme is given as the first part of reaction (3), but several indications in the analysis above suggests that the reaction is more complex. Most important is the fact that the reaction product of the acid initiated polymerization cannot be oxidized to highly conjugated PEDT. Furthermore it seems that the dioxane ring in the EDT monomer is unstable at very low pH (pH<½).

A route to prevent the side-reaction has been demonstrated, simply by raising the pH during the VPP with, e.g., pyridine. The polymer films obtained with base inhibited VPP show very high conductivity, exceeding 1000 S/cm.

Direct chemical polymerization of PEDT-film from EDT and an Fe(III) containing oxidant has been widely used. The films are typically cast from a solution with an organic solvent. The presence of Fe(III) normally result in an very acidic solution (a 40% Fe(III) tosylate solution has a pH less than −1). When the solvent evaporates the acid concentration goes up and the environment becomes more favorable for the described side-reaction. The fact that the side-product cannot be oxidized/reacted to PEDT with Fe(III) then leads to films with “non-PEDT” impurities. It also means that the condition under the polymerization (concentration, solvent, temperature etc.) gets an unexpected high influence on the quality of the polymerized films, because these conditions influence the acidity during the polymerization.

Very different values for the conductivity of PEDT are reported in the literature. One might wonder if this may be due to uncontrolled side-reaction caused by too acidic conditions as it is reported here for vapor phase polymerization of EDT.

### REFERENCES

[1] Groenendaal, L.; Jonas, F.; Freitag, D., Pielartzik, H.; Reynolds, J. R. Adv. Mater. (2000), 7, 481-494.

[2] Kim, J. Y.; Lee, Jung, J. H.; D. E., Joo, Synth. Metals (2002), 126, 311-316.

[3] de Leeuw, D. M.; Kraakman, P. A.; Bongaerts, P. E G .; Mutsaers, C. M. J.; Klaassen, B. B. M. Synth. Metals (1994), 66, 263.

[4] Pettersson, L. A. A.; Carlsson, F.; Inganäs, O.; Arwin, H. Thin Solid Films (1998), 313-314, 356-361.

[5] Winther-Jensen, B.; West, K. Macromolecules (2004) in press.

[6] Lessner et al. U.S. Pat. No. 6,001,291 (1999).

[7] Kim, J.; Kim, E.; Won, Y., Lee, H.; Suh, K. Synth. Metals (2003), 139, 485-489.

[8] West, K.; Jacobsen, T.; Zachau-Christiansen, B.; Careem, M. A.; Skaarup, S. Synth. Metals (1993), 55-57, 1412-1417.

[9] Aleshin, A.; Kiebooms, R.; Menon, R.; Wudl, F.; Heeger, A. J. Phys. Rev. B (1997), 56, 3659-3663.

[10] Mohammadi, A.; Hasan, M.-A.; Liedberg, B.; Lundström, I.; Salaneck, W. R., Synth. Metals (1986), 14 189-197.

[11] Nannini, A.; Serra, G. J. Molecular Electron. (1990), 6, 81-88.

[12] Ueno, T.; Arntz, H.-D.; Flesch, S., Bargon, J. J. Macromol. Sci. Chem. (1988), A25, 1557-1573.

[13] Fu, Y.; Weiss, R. A. Polym. Engn. Sci. (1998), 38, 857-862.

[14] Aasmundtveit, K. E.; Samuelsen, E. J.; Pettersson, L. A. A.; Inganäs, O.; Johannsson, T.; Feidenhansl, R. Synth. Metals (1999), 101, 561-564.

[15] Wudl; F.; Kobayashi, M.; Heeger, A. J., J. Org. Chem. (1984), 49 3382-3384.

[16] Rose, T. L.; Liberto, M. C., Synth. Metals (1989), 31 395-398.

[17] Garreau, S.; Louarn, G.; Bruisson, J. P.; Lefrant, S. Macromolecules (1999), 32, 6807-6812.

[18] Kvarnström, C.; Neugebauer, H.; Ivaska, A.; Sariciftci, N. S. J. Molecular Structure (2000), 521, 271-277.

1. A method for the preparation of a layer of a polymer comprising at least one monomer selected from the group consisting of thiophenes of the formula I and anilines of the formula II 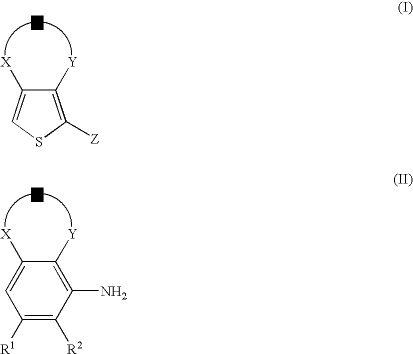
wherein X and Y independently are selected from the group consisting of —CH₂— and —O—, with the proviso that at least one of X and Y is —O—; R is optionally substituted C₁₋₄-alkylene; Z is selected from hydrogen and amino; and R¹ and R² independently are selected from the group consisting of hydrogen, hydroxy, C₁₋₆-alkyl, C₁₋₆-alkoxy, C₁₋₆-alkoxycarbonyl, C₁₋₆-alkylcarbonyl, formyl, aryl, amino, mono- and di(C₁₋₆-alkyl)amino, carbamoyl, mono- and di(C₁₋₆-alkyl)amino-carbonyl, amino-C₁₋₆-alkyl-aminocarbonyl, mono- and di(C₁₋₆-alkyl)amino-C₁₋₆-alkyl-aminocarbonyl, C₁₋₆-alkylcarbonylamino, cyano, carbamido, C₁₋₆-alkanoyl-oxy, sulphono (—SO₃H), C₁₋₆-alkylsulphonyloxy, nitro, sulphanyl, dihalogen-C₁₋₄-alkyl, trihalogen-C₁₋₄-alkyl, and halogens;
on at least a part of a surface of a substrate, said method comprising the steps of:
(a) providing a solution comprising the at least one monomer, an Fe(III) salt, an amine/amide having a pKa value of at least 1.0 selected from tertiary amines, tertiary amides and aromatic amines, and a solvent, wherein the molar ratio of the amine/amide to the Fe(III) salt is in the range of 0.35-1.25;
(b) applying the solution to the part of the surface of the substrate; and
(c) allowing said at least one monomer to polymerize.

2. The method according to claim 1, wherein the monomer is selected from the group consisting of 3,4-ethylenedioxythiophene (EDT), 2-amino-3,4-ethylenedioxythiophene, and 2,3-ethylenedioxyaniline.

3. The method according to claim 1, wherein the monomer is 3,4-ethylenedioxythiophene (EDT).

4. The method according to claim 1, wherein the Fe(III) salt is Fe(III) tosylate.

5. The method according to claim 1, wherein the amine/amide is pyridine.

6. The method according to claim 1, wherein the amine/amide is an aromatic amine.

7. The method according to claim 1, wherein the amine/amide is selected from the group of aromatic amines comprising an —N═ group or an —NR— group.

8. The method according to claim 1, wherein the amine/amide having a pKa value of at least 2.0.

9. The method according to claim 1, wherein the molar ratio of the amine/amide to the Fe(III) salt is in the range of 0.4-1.0.

10. The method according to claim 1, wherein the amine/amide is a mixture of one or more amines and/or one or more amides.

11. The method according to claim 1, wherein the molar ratio between the monomer and the Fe(III) salt is in the range of 1:1.5 to 1:3.0.

12. The method according to claim 1, wherein the molar ratio between the monomer and the Fe(III) salt is in the range of 1:2.0 to 1:2.5.

13. The method according to claim 1, wherein the method comprising mixing the Fe(III) salt and the amine/amide in the solvent before the monomer is added.

14. The method according to claim 1, wherein the method comprising the additional step (d) of washing the polymer film so as to remove Fe(II)/Fe(III) salt and remaining amine/amide.

15. The method according to claim 1, wherein the solution provided in step (a) further comprising a polymer or a polymer precursor.

16. A method for the preparation of a layer of a polymer onto at least a part of a surface of a substrate said method comprising providing a substrate and applying a layer onto at least a part of the substrate, said layer comprising an Fe(III) salt, an amine/amide having a pKa value of at least 1.0 selected from tertiary amines, tertiary amide and aromatic amines, a solvent and said at least one monomer wherein the molar ratio of the amine/amide to the Fe(III) salt is in the range of 0.35-1.25; and allowing said at least one monomer to polymerize wherein said at least one monomer being selected from the group consisting of thiophenes of the formula I and anilines of the formula II 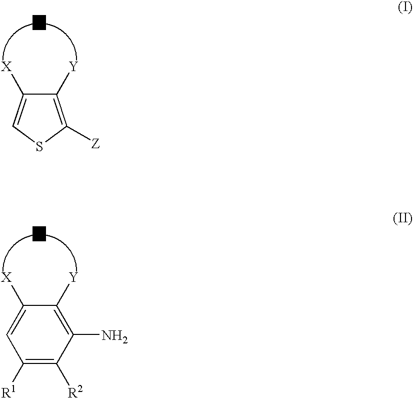
wherein X and Y independently are selected from the group consisting of —CH₂— and —O—, with the proviso that at least one of X and Y is —O—; R is optionally substituted C₁₋₄-alkylene; Z is selected from hydrogen and amino; and R¹ and R² independently are selected from the group consisting of hydrogen, hydroxy, C₁₋₆-alkyl, C₁₋₆-alkoxy, C₁₋₆-alkoxycarbonyl, C₁₋₆-alkylcarbonyl, formyl, aryl, amino, mono- and di(C₁₋₆-alkyl)amino, carbamoyl, mono- and di(C₁₋₆-alkyl)amino-carbonyl, amino-C₁₋₆-alkyl-aminocarbonyl, mono- and di(C₁₋₆-alkyl)amino-C₁₋₆-alkyl-aminocarbonyl, C₁₋₆-alkylcarbonylamino, cyano, carbamido, C₁₋₆-alkanoyl-oxy, sulphono (—SO₃H), C₁₋₆-alkylsulphonyloxy, nitro, sulphanyl, dihalogen-C₁₋₄-alkyl, trihalogen-C₁₋₄-alkyl, and halogens.

17. The method according to claim 16, wherein the molar ratio of the amine/amide to the Fe(III) salt is in the range of 0.4-1.0.

18. A method for the preparation of a layer of a polymer comprising at least one monomer selected from the group consisting of thiophenes of the formula I and anilines of the formula II 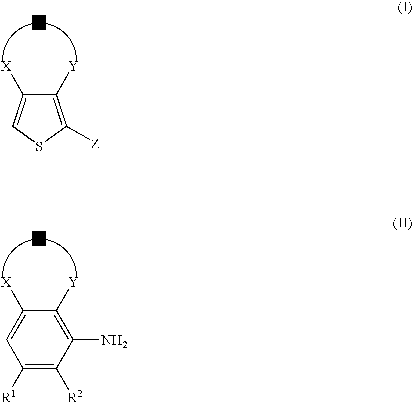
wherein X and Y independently are selected from the group consisting of —CH₂— and —O—, with the proviso that at least one of X and Y is —O—; R is optionally substituted C₁₋₄-alkylene; Z is selected from hydrogen and amino; and R¹ and R² independently are selected from the group consisting of hydrogen, hydroxy, C₁₋₆-alkyl, C₁₋₆-alkoxy, C₁₋₆-alkoxycarbonyl, C₁₋₆-alkylcarbonyl, formyl, aryl, amino, mono- and di(C₁₋₆-alkyl)amino, carbamoyl, mono- and di(C₁₋₆-alkyl)amino-carbonyl, amino-C₁₋₆-alkyl-aminocarbonyl, mono- and di(C₁₋₆-alkyl)amino-C₁₋₆-alkyl-aminocarbonyl, C₁₋₆-alkylcarbonylamino, cyano, carbamido, C₁₋₆-alkanoyl-oxy, sulphono (—SO₃H), C₁₋₆-alkylsulphonyloxy, nitro, sulphanyl, dihalogen-C₁₋₄-alkyl, trihalogen-C₁₋₄-alkyl, and halogens;
on a at least a part of the surface of a substrate, said method comprising the steps of:
(a) providing a solution comprising an Fe(III) salt, an amine/amide having a pKa value of at least 1.0 selected from tertiary amines, tertiary amide and aromatic amines, and a solvent, wherein the molar ratio of the amine/amide to the Fe(III) salt is in the range of 0.35-1.25;
(b) applying the solution to the part of the surface of the substrate so as to form a film on said part of the surface of the substrate;
(c) exposing said film to a vapor comprising the at least one monomer, and allowing said at least one monomer to polymerize.

19. The method according to claim 18, wherein the monomer is selected from the group consisting of 3,4-ethylenedioxythiophene (EDT), 2-amino-3,4-ethylenedioxythiophene, and 2,3-ethylenedioxyaniline.

20. The method according to claim 18, wherein the monomer is 3,4-ethylenedioxythiophene (EDT), the Fe(III) salt is Fe(III) tosylate, and the amine/amide is pyridine.

21. The method according to claim 18, wherein the amine/amide is an aromatic amine.

22. The method according to claim 18, wherein the amine/amide is selected from the group of aromatic amines comprising an —N═ group or an —NR— group.

23. The method according to claim 1, wherein the amine/amide having a pKa value of at least 2.0.

24. The method according to claim 18, wherein the molar ratio of the amine/amide to the Fe(III) salt is in the range of 0.4-1.0.

25. The method according to claim 18, wherein the amine/amide is a mixture of one or more amines and/or one or more amides.

26. The method according to claim 1, wherein the molar ratio between the monomer and the Fe(III) salt is in the range of 1:1.5 to 1:3.0.

27. The method according to claim 18, wherein the molar ratio between the monomer and the Fe(III) salt is in the range of 1:2.0 to 1:2.5.

28. The method according to claim 18, wherein the method comprising mixing the Fe(III) salt and the amine/amide in the solvent before the monomer is added.

29. The method according to claim 18, wherein the method comprising the additional step (d) of washing the polymer film so as to remove Fe(II)/Fe(III) salt and remaining amine/amide.

30. The method according to claim 18, wherein the solution in step (a) further comprises a polymer or a polymer precursor.

31. A stabilized polymerizable solution comprising at least one monomer an Fe(III) salt, an amine/amide and a solvent, said at least one monomer being selected from the group consisting of thiophenes of the formula I and anilines of the formula II 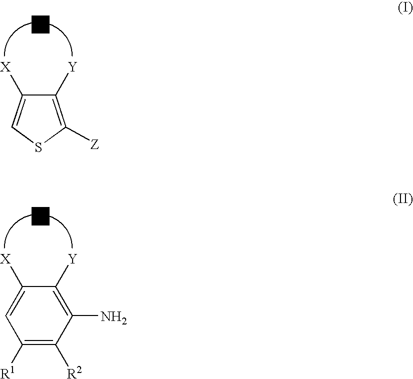
wherein X and Y independently are selected from the group consisting of —CH₂— and —O—, with the proviso that at least one of X and Y is —O—; R is optionally substituted C₁₋₄-alkylene; Z is selected from hydrogen and amino; and R¹ and R² independently are selected from the group consisting of hydrogen, hydroxy, C₁₋₆-alkyl, C₁₋₆-alkoxy, C₁₋₆-alkoxycarbonyl, C₁₋₆-alkylcarbonyl, formyl, aryl, amino, mono- and di(C₁₋₆-alkyl)amino, carbamoyl, mono- and di(C₁₋₆-alkyl)amino-carbonyl, amino-C₁₋₆-alkyl-aminocarbonyl, mono- and di(C₁₋₆-alkyl)amino-C₁₋₆-alkyl-aminocarbonyl, C₁₋₆-alkylcarbonylamino, cyano, carbamido, C₁₋₆-alkanoyl-oxy, sulphono (—SO₃H), C₁₋₆-alkylsulphonyloxy, nitro, sulphanyl, dihalogen-C₁₋₄-alkyl, trihalogen-C₁₋₄-alkyl, and halogens; said amine/amide having a pKa value of at least 1.0 and being selected from tertiary-amines, tertiary amides and aromatic amines; and wherein the molar ratio of the amine/amide to the Fe(III) salt is in the range of 0.35-1.25.

32. A stabilized polymerizable solution of claim 31, wherein the molar ratio of the amine/amide to the Fe(III) salt is in the range of 0.4-1.0.

33. A substrate comprising a layer of poly(3,4-ethylenedioxythiophene) on at least a part of the surface thereof, said layer having a conductivity of at least 700 S/cm.

34. A substrate comprising a layer of a conducting polymer, said conducting polymer being obtained from polymerizing at least one monomer in the presence of Fe(III) salt and an amine/amide having a pKa value of at least 1.0 and being selected from tertiary amines, tertiary amides and aromatic amines; and wherein the molar ratio of the amine/amide to the Fe(III) salt is in the range of 0.35-1.25, and wherein said at least one monomer being selected from the group consisting of thiophenes of the formula I and anilines of the formula II 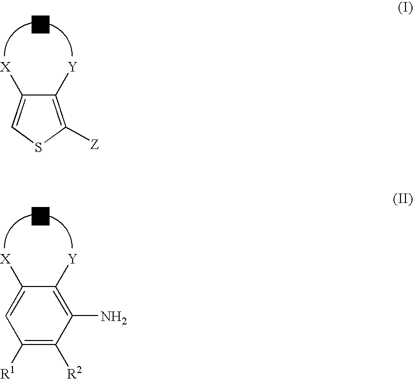
wherein X and Y independently are selected from the group consisting of —CH₂— and —O—, with the proviso that at least one of X and Y is —O—; R is optionally substituted C₁₋₄-alkylene; Z is selected from hydrogen and amino; and R¹ and R² independently are selected from the group consisting of hydrogen, hydroxy, C₁₋₆-alkyl, C₁₋₆-alkoxy, C₁₋₆-alkoxycarbonyl, C₁₋₆-alkylcarbonyl, formyl, aryl, amino, mono- and di(C₁₋₆-alkyl)amino, carbamoyl, mono- and di(C₁₋₆-alkyl)amino-carbonyl, amino-C₁₋₆-alkyl-aminocarbonyl, mono- and di(C₁₋₆-alkyl)amino-C₁₋₆-alkyl-aminocarbonyl, C₁₋₆-alkylcarbonylamino, cyano, carbamido, C₁₋₆-alkanoyl-oxy, sulphono (—SO₃H), C₁₋₆-alkylsulphonyloxy, nitro, sulphanyl, dihalogen-C₁₋₄-alkyl, trihalogen-C₁₋₄-alkyl, and halogens; said amine/amide having a pKa value of at least 1.0 and being selected from tertiary amines, tertiary amides and aromatic amines.
